(19) United States
(12) Patent Application Publication
(10) Pub. No.: US 2011/0096135 A1
(43) Pub. Date: Apr. 28, 2011

(54) AUTOMATIC LABELING OF A VIDEO SESSION

(75) Inventors: Rajesh Kutpadi Hegde, Redmond, WA (US); Zicheng Liu, Bellevue, WA (US)

(73) Assignee: Microsoft Corporation, Redmond, WA (US)

(21) Appl. No.: 12/604,415

(22) Filed: Oct. 23, 2009

(51) Int. Cl. H04N 5/262; H04N 7/14; G06T 7/00; G08B 13/14

(52) U.S. Cl. 348/14.07; 382/118; 348/231.5; 340/572.1; 348/E07.077; 348/E05.051

(57) ABSTRACT

Described is labeling a video session with metadata representing a recognized person or object, such as to identify a person corresponding to a recognized face when that face is being shown during the video session. The identification may be made by overlaying text on the video session, e.g., the person's name and/or other related information. Facial recognition and/or other (e.g., voice) recognition may be used to identify a person. The facial recognition process may be made more efficient by using known narrowing information, such as calendar information that indicates who the invitees are to a meeting that is being shown in the video session.

### BACKGROUND

Video conferencing has become a popular way to participate in meetings, seminars and other such activities. In a multi-party video conferencing session, users often see remote participants on their conference displays but have no idea who that participant is. Other times users have a vague idea of who someone is, but would like to know for certain, or may know the names of some people, but not know which name goes with which person. Sometimes users want to know not only a person's name, but other information, such as what company that person works for, and so forth. This is even more problematic in a one-to-many video conference where there may be relatively large numbers of people who do not know each other.

At present, there is no way for users to obtain such information, other than by chance or by multiple (often time consuming) introductions where people verbally introduce themselves (including remotely over video), or if a person has a name tag, name plate or the like that the user is able to see. It is desirable for users to have information about others video conferencing sessions, including without having to have verbal introductions and the like.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an entity such as a person or object is recognized, with associated metadata used to identify that entity when it appears in a video session. For example, when a video session shows a person's face or an object, that face or object may be labeled (e.g., via text overlay) with a name and/or other related information.

In one aspect, an image of a face that is shown within a video session is captured. Facial recognition is performed to obtain metadata associated with the recognized face, The metadata is then used to labeling the video session, such as to identify a person corresponding to the recognized face when the recognized face is being shown during the video session. The facial recognition matching process may be narrowed by other, known narrowing information, such as calendar information that indicates who the invitees are to a meeting that is being shown in the video session

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example environment for labeling a video session with metadata that identifies a sensed entity (e.g., person or object).

FIG. 2 is a block diagram representing labeling a face appearing in a video session based upon facial recognition.

FIG. 3 is a flow diagram representing example steps for associating metadata with an image of an entity by searching for a match.

FIG. 4 shows an illustrative example of a computing environment into which various aspects of the present invention may be incorporated.

### DETAILED DESCRIPTION

Various aspects of the technology described herein are generally directed towards automatically inserting metadata (e.g., overlaid text) into a live or prerecorded/played back video conferencing session based on a person or object currently on the display screen. In general, this is accomplished by automatically identifying the person or object, and then using that identification to retrieve relevant information, such as the person's name and/or other data.

It should be understood that any of the examples herein are non-limiting. Indeed, the use of facial recognition is described herein as one type of identification mechanism for persons, however other sensors, mechanisms and/or ways that work to identify people, as well as to identify other entities such as inanimate objects, are equivalent. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing, data retrieval, and/or video labeling in general.

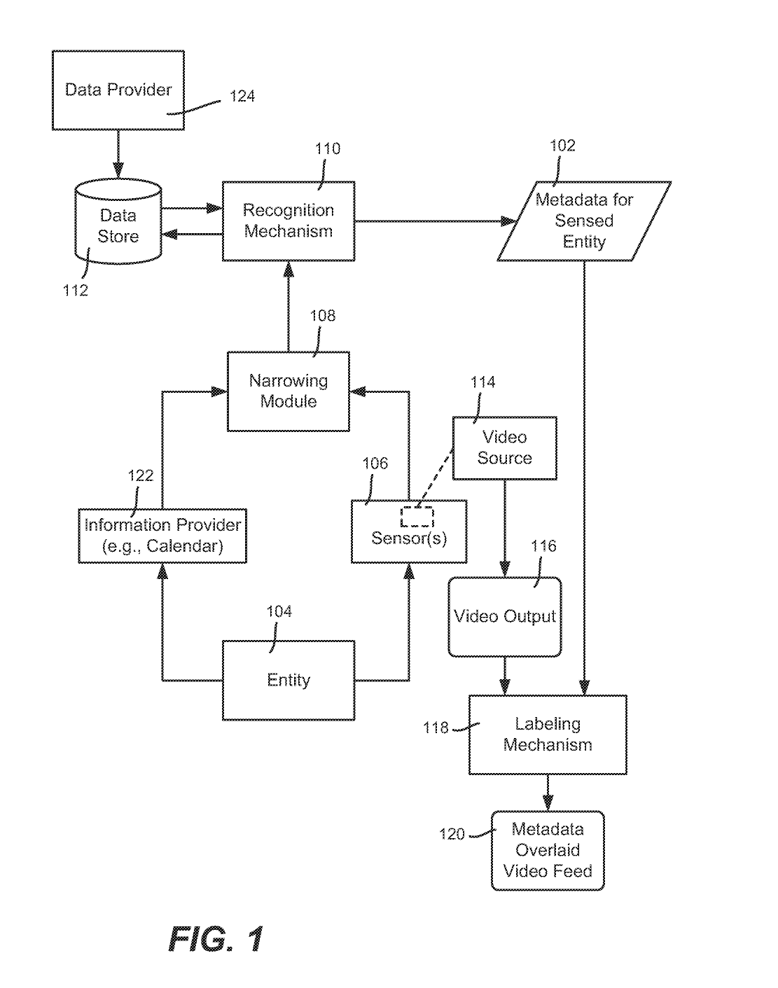

FIG. 1 shows a general example system for outputting metadata 102 based on identification of an entity 104 (e.g., a person or object) that is recognized. One or more sensors 106, such as a video camera, provides sensed data regarding that entity 104, such as frame containing a facial image, or a set of frames. An alternative camera may be one that captures a still image, or set of still images. A narrowing module 108 receives the sensed data, and for example, may choose (in a known manner) one frame that is likely to best represent the face for purposes of recognition. Frame selection may alternatively be performed elsewhere, such as in a recognition mechanism 110 (described below).

The narrowing module 108 receives data from the sensor or sensors 106 and provides it to a recognition mechanism 110; (note that in an alternative implementation, one or more of the sensors may more directly provide their data to the recognition mechanism 110). In general, the recognition mechanism 110 queries a data store 112 to identify the entity 104 based on the sensor-provided data. Note that as described below, the query may be formulated to narrow the search based upon narrowing information received from the narrowing module 108.

Assuming that a match is found, the recognition mechanism 110 outputs a recognition result, e.g., the metadata 102 for the sensed entity 104. This metadata may be in any suitable form, e.g., an identifier (ID) useful for further lookup, and/or a set of results already looked up, such as in the form of text, graphics, video, audio, animation, or the like.

A video source 114 such as a video camera (which also may be a sensor as indicated by the dashed block/line) or a video playback mechanism, provides a video output 116, e.g., a video stream, When the entity 104 is shown, the metadata 102 is used (directly or to access other data) by a labeling mechanism 118 to associate corresponding information with the video feed. In the example of FIG. 1, the resultant video feed 120 is shown as being overlaid with the metadata (or information obtained via the metadata) such as text, however this is only one example.

Another example output is to have a display or the like viewable to occupants of a meeting or conference room, possibly accompanying a video screen. When a speaker stands behind a podium, or when one person of a panel of speakers is talking, the person's name may appear on the display. A questioner in the audience may similarly be identified and have his or her information output in this way.

For facial recognition, the search of the data store 112 may be time consuming, whereby narrowing the search based upon other information r may be more efficient. To that end, the narrowing module 108 also may receive additional information related to the entity from any suitable information provider 122 (or providers). For example, a video camera may be set up in a meeting room, and calendar information that establishes who are the invitees to the meeting room at that time may be used to help narrow the search. Conference participants typically register for the conference, and thus a list of those participants may be provided as additional information for narrowing the search. Other ways of obtaining narrowing information may include making predictions based on organization information, learning meeting attendance patterns based upon past meetings (which people typically go to meetings together) and so forth. The narrowing module 108 can convert such information to a form useable by the recognition mechanism 110 in formulating a query or the like to narrow the search candidates.

Instead of or in addition to facial recognition, various other types of sensors are feasible for use in identification and/or narrowing. For example, a microphone can be coupled to voice recognition technology that can match a speaker's voice to a name; a person can speak theft name as a camera captures their image, with the name recognized as text. Badges and/or nametags may be read to directly identify someone, such as via text recognition, or by being outfitted with visible barcodes, or RFID technology or the like. Sensing may also be used for narrowing a facial or voice recognition search; e.g., many types of badges are already sensed upon entry to a building, and/or RFID technology can be used determine who has entered a meeting or conference room. A cellular telephone or other device may broadcast a person's identity, e.g., via Bluetooth® technology.

Moreover, the data store 112 may be populated by a data provider 124 with data that is less than all available data that can be searched. For example, a corporate employee database may maintain pictures of its employees as used with their ID badges. Visitors to a corporate site may be required to have their photograph taken along with providing their name in order to be allowed entry. A data store of only employees and current visitors may be built and searched first. For a larger enterprise, an employee that enters a particular building may do so via their badge, and thus the currently present employees within a building are generally known via a badge reader, whereby a per-building data store may be searched first.

In the event a suitable match (e.g., to a sufficient probability level) is not found while searching, the search may be expanded. Using one of the examples above, if one employee enters a building with another and does not use his or her badge for entry, then a search of the building's known occupants will not find a suitable match. In such a situation, the search may be expanded to the entire employee database, and so on (e.g., previous visitors). Note that ultimately the result may be “person not recognized” or the like. Bad input may also cause problems, e.g., poor lighting, poor viewing angle, and so forth.

An object may be similarly recognized for labeling. For example, a user may hold up a device or show a picture, such as of a digital camera. A suitable data store may be searched with an image to find the exact brand name, model, suggested retail price, and so on, which may then be used to label the user's view of the image.

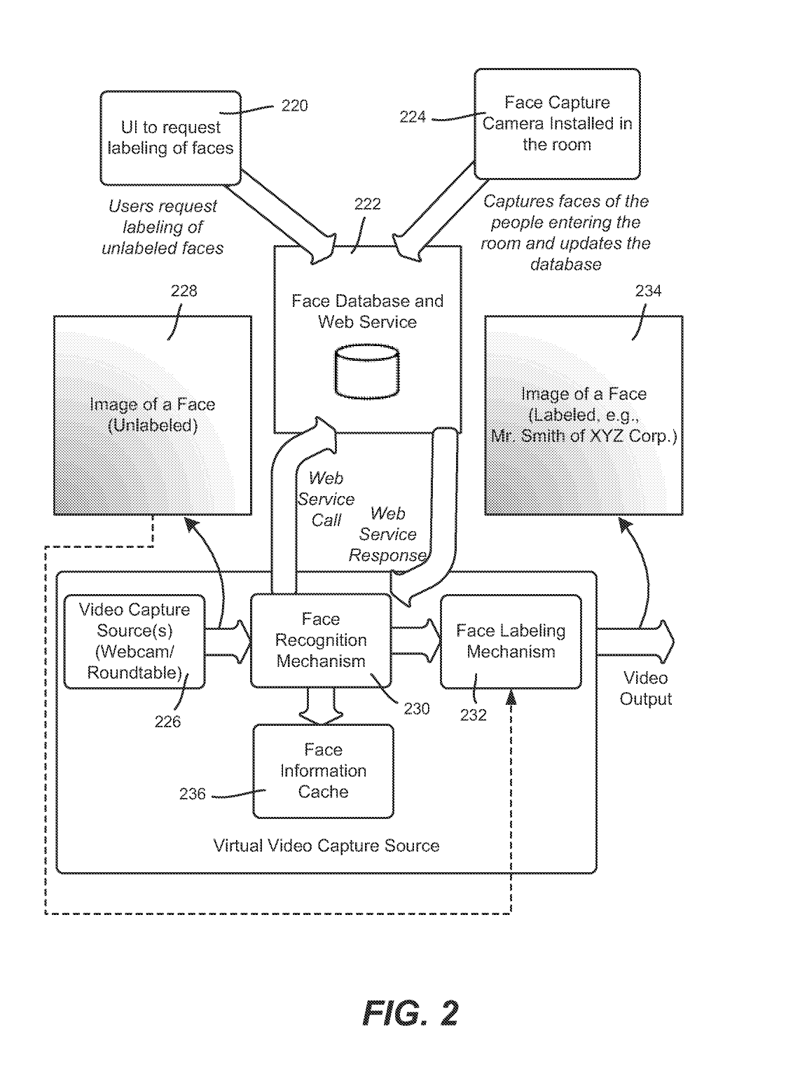

FIG. 2 shows a more specific example that is based upon facial recognition A user interacts with a user interface 220 to request that one or more faces be labeled by a service 222, e.g., a web service. A database at the web service may be updated with a set of faces captured by a camera 224, and thus may start obtaining and/or labeling faces in anticipation of a request. Automatic and/or manual labeling of faces may also be performed to update the database.

When a video capture source 226 obtains a facial image 228, the image is provided to the face recognition mechanism 230, which calls the web service (or any other mechanism that provides metadata for a given face or entity) requesting a label (or other metadata) be returned with the face. The web service responds with the label, which is then passed to a face labeling mechanism 232, such as one that overlays text on the image, thereby providing a labeled image 234 of the face. The face recognition mechanism 230 can store facial/labeling information in a local cache 236 for efficiency in labeling the face the next time that the face appears.

The facial recognition thus may be performed at a remote service, by sending the image of the person's face, possibly along with any narrowing information that is known, to the service. The service may then perform the appropriate query formulation and/or matching. However, some or all of the recognition may be performed locally. For example, the user's local computer may extract a set of features representative of a face, and user or send those features to search a remote database of such features. Still further, the service may be receiving the video feed; if so, a frame number and location within the frame where the face appears may be sent to the service whereby the service can extract the image for processing.

Moreover, as described above, the metadata need not include a label, but rather may be an identifier or the like from which a label and/or other information may be looked up. For example, an identifier may be used to determine a person's name identity, biographical information such as the person's company, links to that person's website, publications, and so forth, his or her telephone number, email address, place within an organizational chart, and the like.

Such additional information may be dependent on user interaction with the user interface 220. For example, the user may at first see only a label, but be able to expand and collapse additional information with respect to that label. A user may be able to otherwise interact with a label (e.g., click on it) to obtain more viewing options.

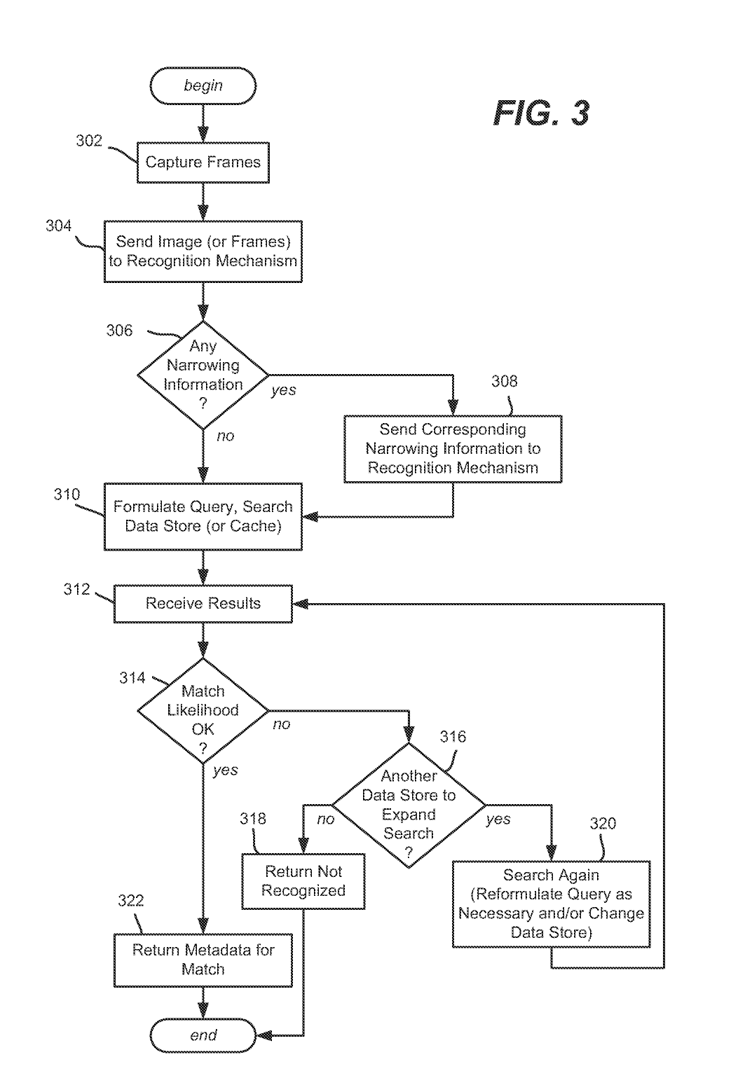

FIG. 3 summarizes an example process for obtaining labeling information via facial recognition, beginning at step 302 where video frames are captured. An image can be extracted from the frames, or one or more frames themselves may be sent to the recognition mechanism, as represented by step 304.

Steps 306 and 308 represent the use of narrowing information when available. As described above, any narrowing information may be used to make the search more efficient, at least initially. The above example of calendar information used to provide a list of meeting attendees, or a registration list of conference participants, can make a search far more efficient.

Step 310 represents formulating a query to match a face to a person's identity. As described above, the query may include a list of faces to search. Note that step 310 also represents searching a local cache or the like when available.

Step 312 represents receiving the results of the search. In the example of FIG. 3, the results of the first search attempt may be an identity, or a “no match” result, or possibly a set of candidate matches with probabilities. Step 314 represents evaluating the result; if the match is good enough, then step 322 represents returning metadata for the match.

If no match is found, step 316 represents evaluating whether the search scope may be expanded for another search attempt. By way of example, consider a meeting in which someone who was not invited decides to attend. Narrowing the search via calendar information will result in not finding a match for that uninvited person. In such an event, the search scope may be expanded (step 320) in some way, such as to look for people in the company who are hierarchically above or below the attendees, e.g., the people they report to or who report to them. Note that the query may need to be reformulated to expand the search scope, and/or a different data store may be searched. If still no match is found at step 314, the search expansion may continue to the entire employee database or visitor database if needed, and so on. If no match is found, step 318 can return something that indicates this non-recognized state.

### Exemplary Operating Environment

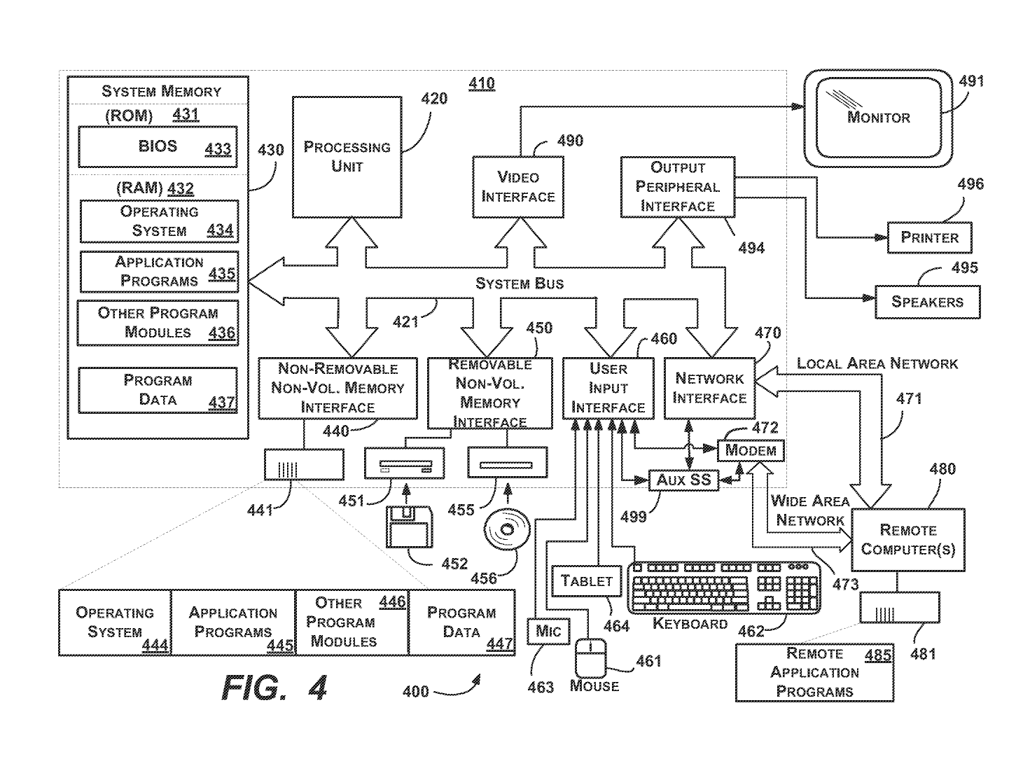

FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interlace 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environ environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modern 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions. and equivalents falling within the spirit and scope of the invention.

What is claimed is:

1. In a computing environment, a system comprising, a sensor set comprising at least one sensor, a recognition mechanism that obtains and outputs recognition metadata associated with a recognized entity based upon information received from the sensor, and a mechanism that associates information corresponding to the metadata with video output showing that entity.

2. The system of claim 1 wherein the sensor set comprises a video camera that further provides the video output.

3. The system of claim 1 wherein the recognition mechanism performs facial recognition.

4. The system of claim 3 wherein the recognition mechanism is coupled to a data store that contains face-related data and the metadata for each set of face-related data, and wherein the recognition mechanism obtains an image of a face from the sensor set, and searches the data store for a matching set of lace-related data to obtain the metadata.

5. The system of claim 4 wherein the data store is prefilled so as to contain only face-related data that is more likely to be matched than a larger set of face-related data that is available for searching.

6. The system of claim 4 wherein the recognition mechanism receives narrowing information from an information provider, and narrows the search of the data store based upon the narrowing information.

7. The system of claim 6 wherein the narrowing information comprises data that indicates who is likely to be present in the video output at a time of capturing video input corresponding to the video output.

8. The system of claim 1 wherein the mechanism that associates the information corresponding to the metadata with the video output labels the video output with a name of the entity.

9. The system of claim 1 wherein the mechanism that associates the information corresponding to the metadata with the video output uses the metadata as a reference to that information.

10. The system of claim 1 wherein the sensor set includes a camera, a microphone, an RFID reader, or a badge reader, or any combination of a camera, a microphone, an RFID reader, or a badge reader.

11. The system of claim 1 wherein the recognition mechanism communicates with a web service to obtain the metadata.

12. In a computing environment, a method comprising:
receiving data representative of a person or object;
matching the data to metadata; and
inserting information corresponding to the metadata into a video session when the entity is currently being shown during the video session.

13. The method of claim 12 wherein receiving the data representative of the person or object comprises receiving an image, and wherein matching the data to the metadata comprises searching a data store for a matching image.

14. The method of claim 12 further comprising receiving narrowing information, and wherein matching that data to the metadata comprises formulating a query that is based at least in part on the narrowing information.

15. The method of claim 12 wherein receiving the data comprises receiving an image of a face, and wherein matching the data to the metadata comprises performing facial recognition.

16. The method of claim 12 wherein inserting the information corresponding to the metadata comprises overlaying the video session with text.

17. The method of claim 12 wherein inserting the information corresponding to the metadata comprises labeling the entity with a name.

18. One or more computer-readable media having computer-executable instructions, which when executed perform steps, comprising:
capturing an image of a face that is shown within a video session;
performing facial recognition to obtain metadata associated with the recognized face; and
labeling the video session based upon the metadata so as to identify a person corresponding to the recognized face when the recognized face is being shown during the video session.

19. The one or more computer-readable media of claim 18 having further computer-executable instructions, comprising, using narrowing information to assist in reducing a number of candidate faces that are searched when performing the facial recognition, wherein the narrowing information is based upon calendar data, sensed data, registration data, predicted data or pattern data, or any combination of calendar data, sensed data, registration data, predicted data or pattern data.

20. The one or more computer-readable media of claim 18 having further computer-executable instructions, comprising, determining that no suitable match is found during a first facial recognition attempt, and expanding a search scope in a second facial recognition attempt.
